(19) United States
(12) Patent Application Publication
(10) Pub. No.: US 2021/0046864 A1
(43) Pub. Date: Feb. 18, 2021

(54) INDICATIONS FOR VEHICLES

(71) Applicant: Michael ELGRABLY, Tel Aviv (IL)

(72) Inventor: Michael ELGRABLY, Tel Aviv (IL)

(21) Appl. No.: 17/041,507

(22) PCT Filed: Mar. 25, 2019
(86) PCT No.: PCT/IL2019/050335

§ 371 Date: Sep. 25, 2020

(30) Foreign Application Priority Data
Mar. 26, 2018 (IL) 258413

(51) Int. Cl. B60Q 1/30; B60Q 1/22; B60Q 1/24; B60Q 1/26; B60Q 1/32; B60Q 1/38; B60Q 1/44; B60Q 1/50

(52) U.S. Cl. CPC B60Q 1/302; B60Q 1/22; B60Q 1/24; B60Q 1/503; B60Q 1/32; B60Q 1/38; B60Q 1/444; B60Q 1/2607

(57) ABSTRACT

A display on a front, back or side of a vehicle, linked to an on board computer or a can-bus of said vehicle for displaying changes in the trajectory of the vehicle, wherein rear display provides a non-binary illuminated warning in response to detected changes in trajectory of the vehicle.

### BACKGROUND

Road accidents happen frequently. In the US, tens of thousands are killed in road accidents and many more are wounded. Worldwide, some 1.25 million people are killed in road cashes and 20-50 million are disabled. Road traffic crashes are the 9^{th} leading cause of deaths globally and account for 2.2% of all deaths. Road crashes cost USD $518 billion globally, costing individual countries from 1-2% of their annual GDP.

In the US, 32% of fatalities are linked to drunk driving, where a driver's decision making ability is impaired due to alcohol. Drugs have a similar affect regarding the decision making process. So does tiredness due to lack of sleep. 31% of the accidents are due to speeding, with drivers going to fast for the road conditions and not having time to stop to avoid a collision. 16% of accidents are attributed to distractions, such as incoming messages on mobile phones, and worse, on drivers actively testing whilst driving. A further 11% are attributed to adverse weather conditions. In common with all of these causes, is the fact that all are related to insufficient warning to take effective action. With greater warning regarding other road users and providing more information to other road users, the number of accidents can be drastically reduced.

52.15% of fatalities are drivers of vehicles and a further 20% are passengers. Some 13.1% of fatalities are motorcyclists and 12.1% are pedestrians. If motorcyclists and pedestrians were more aware of what drivers of vehicles were up to with a longer warning period, the number of accidents and fatalities could be reduced.

Road traffic crashes are predictable and can be prevented. Many countries have shown sharp reductions in the number of crashes and casualties by taking actions including: raising awareness of, legislating and enforcing laws governing speed limits, alcohol impairment, seat-belt use, child restraints and safety helmets, formulating and implementing transport and land-use policies that promote safer and more efficient trips; encouraging the use of safer modes of travel, such as public transport; and incorporating injury prevention measures into traffic management and road design and making vehicles more protective and visible for occupants, pedestrians and cyclists; using daytime running lights, high-mounted brake lights and reflective materials on cycles, carts and other non-motorized forms of transport.

Motorcycles are less stable than four-wheeled vehicles and lack protective vehicle structure to minimize injuries when crashes occur. The result is substantially higher fatality rates for motorcyclists, whether based on registered vehicles or miles driven. In the United States, motorcycles comprise only three percent of registered vehicle and less than one percent of vehicle miles traveled. However, despite their limited presence, motorcycles account for about 15% of all motor vehicle fatalities. A car driver may fail to notice a motorcycle coming from behind or trying to pass. If the driver stops or slows down suddenly, he may cause a serious accident. If a passenger suddenly opens a car door and hits a motorcycle (known as dooring) the motorcyclist may be thrown from the bike. The ongoing traffic could collide with the motorcycle, resulting in a fatal accident involving multiple vehicles. In some cases, the motorcyclist may avoid a collision with other cars on the road, but may still suffer a traumatic brain injury due to hard contact with solid objects, such as a lamp-post, a tree in the roadside, and the road itself. Such injuries could be severe enough to cause amputations and even death.

Dooring affects pedal cyclists as well as motor-cyclists. As more people turn to bicycling for local travel, reported doorings have dramatically increased in many older cities where drivers or passengers exit into adjacent travel or bike lanes. Defining and measuring the incidence, prevalence or proportionality of doorings, crashes, injuries and fatalities is difficult Even so, several cities in North America report doorings (however variously defined or collected) among their top three causes of bicycle-vehicle collisions. The recent popularity of electric bicycles only increases the risk.

Warning systems per se. are not new. Vehicles have rear lights for indicating their presence to other road users in conditions of poor visibility. Brake lights indicate to following vehicles that a driver has put his/her foot on the brake and is slowing down. In some cases, the intensity of the brake light indicates how hard the brakes are being pressed.

The first brake lamps appeared as early as 1905, though the requirements for brake lamps took a bit longer to catch on. For many drivers, hand signals were a significant enough warning to other drivers of their intent to stop or turn. This reliance on hand signals made it difficult for many drivers to enjoy their automobiles at night, though, making the brake light a necessity. By 1928, 11 states in the United States had made brake lights a requirement on cars. These lights, which were different from modern tail lamps, were typically manually illuminated by the driver rather than automatically illuminated like they are now. While this method wasn't perfect, it was the beginning of the brake lights evolution.

While the development of the first brake light isn't exactly known, there is one important brake light feature that has a storied history—the third brake light. Psychologist John Voevodsky first introduced the third brake light, which is a requirement on modern-day vehicles, to the automotive industry in 1974. Voevodsky studied the effects of driving on attention, testing a small, inexpensive gadget on 343 taxicabs in San Francisco. This new light, which would eventually become the third brake light, made it easier for other drivers to recognize if the car in front of them was slowing down. A 10-month study was then executed to examine the third brake light's effectiveness, randomly assigning taxis with or without the extra brake light. It was discovered that the third brake light caused 60.6% less rear-end collisions. After discovering the increased safety the third brake light provided, it quickly became a requirement on all automobiles.

Turn signals—formally called “direction indicators” or “directional signals”, and informally known as “directionals”, “blinkers”, “indicators” or “flashers”—are blinking lamps mounted near the left and right front and rear corners of a vehicle, and sometimes on the sides or on the side mirrors of a vehicle, activated by the driver on one side of the vehicle at a time to advertise intent to turn or change lanes towards that side.

Electric turn-signal lights date from as early as 1907. The modern flashing turn signal was patented in 1938 and later most major automobile manufacturers offered this feature. Nowadays most countries require turn signals on all new vehicles that are driven on public roadways.

The rear facing warnings displayed on a modern vehicle include rear lights illuminated at night, red brake lights to the left, right and centrally—usually at the top of the rear window, and blinking turn signal “indicator” lights on rear corners of the vehicle and/or on side mirrors that are amber colored and indicate that the driver intends to turn. The brake lights come on automatically, and are triggered by pressure on the brake pedals. The indicators are controlled by the driver, who generally knocks an indicator lever protruding from the steering column to the side of the steering wheel in an upwards or downwards direction, and this causes flashing of the turn signal at the side of the vehicle to which the vehicle would turn were the steering wheel to be turned in the direction of motion imparted to the indicator lever. Following the vehicle moving in the direction indicated and straightening up, the turn signal light is generally automatically extinguished. Sometimes the driver can control the extinguishing of this turn signal light and actively switch it off.

Vehicles also typically have a control button under the control of the driver that enables both left and right indicators to be activated simultaneously. This mode of operation is used to indicate that the vehicle itself is a hazard, such as if there is engine failure, overheating of the gearbox or a puncture, and is activated by the driver (or a passenger), typically by a switch on the dashboard situated between the front seats.

U.S. Pat. No. 2,513,712 to Coombs titled “Motorcar Signal System” shows an enclosing case to be attached to a vehicle to be viewed from behind, that includes three compartments 22, 23, 24 with colored glass 26, 27, 28 that have the colors red, yellow and green or any other contrasting colors. In column 2 lines 24 to Column 3 line 2, activation of the lights so that the yellow light shows unless the accelerator is depressed, and the green light shows if the accelerator is depressed.

U.S. Pat. No. 5,642,094 to Marcella titled “Type of Stop Expectation Warning” describes a blinking yellow rear light for indicating that the driver is taking the foot off the accelerator, and is similar to the flashing yellow light indicating that a traffic light is expected to turn red.

In recent years much progress has been made in radar systems for vehicles and these provide indication to drivers of other road users, of the drivers own poor habits such as speeding and changing lanes without warning, and so on. In many countries, the government provides a discount in road tax for vehicles that have such systems installed, so that over a short period, the discount covers the cost of such systems The interest of the government for so doing is clear, since traffic accidents result in road blockages and traffic jams, in hospitalization, in lost work-days, and in damage to the road infrastructure. Despite these improvements, there is a need for further warning systems and the present invention is directed to addressing this need.

### SUMMARY OF THE INVENTION

Embodiments of the present invention are directed to providing augmented warning signals displayed on a vehicle that provide warning to other road users of possible hazards thereby providing supplementary information and early warning regarding likely imminent trajectory of a vehicle and its driver to shortening the response time of other users and reduce risk of accidents.

A first aspect of the invention is directed to providing a rear display on at least part of a rear of a vehicle, said rear display comprising a pixilated array said rear display being linked to an on board computer, an independent processing unit or a can-bus of said vehicle to monitor changes in the trajectory of the vehicle, wherein said rear display provides a real-time, non-binary illuminated warning in response to detected changes in trajectory of the vehicle.

Preferably the pixilated array is multicolor.

Optionally the pixilated array is an array of LED pixels.

In some embodiments, wherein the vehicle has an automatic gear box, said display for indicating a reduction in pressure on the accelerator pedal as detected by said onboard computer, and for displaying an appropriate indication on the rear display.

Optionally an appropriate indication is a yellow illumination of at least part of the rear display. Optionally a size of the yellow illuminated part of the rear display is an indication of the rate of deceleration.

Optionally said vehicle comprises an onboard video system with image analysis, a radar system or ladar system for detecting hazards in front of the vehicle, and displays information corresponding to the hazards on the rear display to provide said information to drivers of following vehicles.

Optionally, if at least one of an onboard computer, a radar, a ladar (laser based system) or a video system detect that said vehicle is moving to the left or right, either via the steering wheel, or from a change in proximity to lane markings detected by a laser based driver warning system, such as AWACS™ or Mobileye™, detected information selected from that displayed to the driver of the system provided with the laser based driver warning system is displayed as a non-binary display on the rear display to the following driver.

Typically, the displayed information is informative.

Optionally, the displayed information comprises at least one glyph.

In preferred embodiments, the displayed information is intuitive.

Optionally, the displayed information is symbolic.

In some embodiments, a red octagon indicates stop, and a triangular symbol preferably a triangle with a red border indicates a warning.

In some embodiments, a graphical element, number of word displayed within the triangle provides additional information.

In some embodiments, said information displayed is graphical.

In some embodiments, said information is alpha-numeric.

In some embodiments, said information a number indicates speed.

In some embodiments, said information a letter or word provides information regarding trajectory of the vehicle.

In some embodiments, colors of the display are intuitive with red indicating a hazard, yellow providing advanced warning of likely change in trajectory and green indicating that said vehicle is likely to continue on its trajectory. The intensity of the color or the size of the colored element may provide an intuitive indication of the magnitude of the indicated effect.

Optionally the display comprises a graded triangle or a line, the extent of which indicates the extent of a parameter.

In some embodiments, a long line to the left or a triangle pointing to the left or at left of the display indicates a sharp deviation to the left and a long line to the right or a triangle pointing to the right indicates a sharp deviation to the right.

In some embodiments, a graded green forward triangle indicates acceleration of the vehicle.

In some embodiments, a visual indication of any significant turning of steering wheel by a driver of a vehicle is displayed on rear display for viewing by the driver of a following vehicle.

In some embodiments, the visual indication comprises a constant illumination of turn signals that contrasts with the flashing turn signal that indicates an intention to turn.

A second aspect of the invention is directed to providing a ground illuminating lamp projected on the ground to the side of a vehicle.

Optionally, the ground illuminating lamp is coupled to an onboard computer or can-bus for providing advanced warning of imminent lane changes and turning. The intensity of the signal or the distance from vehicle illuminated may be synchronized with the steering column.

Optionally, the ground illuminating lamp provides sideways illumination of ground alongside the vehicle when stationary to a distance of about 1 meter, to indicate to other road users, particularly passersby such as motorcyclists or cyclists that said vehicle has recently parked, thereby warning of a possible door opening.

Optionally, the ground illuminating lamp of a vehicle that has just parked provides an indication of said vehicle having recently parked by a low level illumination of the ground alongside the vehicle.

Preferably, the ground illuminating lamp of a vehicle that has just parked is configured such that turning off engine, raising the handbreak or putting an automatic vehicle into Parking mode, or an internal handle of a door being touched by a driver or passenger increases intensity of illumination of the ground to the side of the vehicle or causes said ground illuminating lamp to flash and or to change color thereby warning other road users of a clear imminent danger.

In some embodiments, the ground illuminating lamp only illuminates ground on same side of the vehicle as said inner handle of a door.

A third aspect is directed to a rear lamp of a vehicle directed at ground behind said vehicle for illuminating ground behind the vehicle as an indication that said vehicle is reversing.

In one embodiment, distance from the vehicle illuminated by said lamp provides an indication of a speed of reversal or length of the reversing vehicle.

A fourth aspect is directed to a forward facing display of a vehicle provided on front of said vehicle to provide an indication of an intent of a driver of said vehicle to road users in front of the vehicle.

Optionally, the front facing display is coupled to at least one of a video camera with image analysis, a radar system, a laser system, an onboard computer a satellite navigation system or a can-bus.

In one application the video camera with image analysis, radar system or laser system are configured for detecting pedestrians and the front display system is configured to indicate to said pedestrians whether it is safe to cross.

In one embodiment, if a crossing and a person waiting to cross are detected, if the vehicle is slowing down as it approaches or stops, a green walking man is displayed on said front facing display to indicate to persons waiting to cross that it is safe to do so.

Preferably if said vehicle is going too fast to stop, an image of a red man standing could indicate this fact to pedestrians.

Displays of the invention may be installed in vehicles that are controlled manually, in a semi automated cruise control mode, independently, combined independently or are fully autonomous.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In particular, it will be appreciated that the schematic illustrations are not to scale, and the thickness of some very thin layers is exaggerated. In the accompanying drawings:

FIG. 1 is a schematic representation of the rear of a vehicle, specifically a family saloon car 2, showing possible positions for display screens in addition to the license plate and rear lights and turn indicators, where 10A and 10B are to the rear left and rear right of the vehicle on panels near the lid of the trunk;

FIG. 2 is a schematic representation of the rear of a sports car 4, such as a corvette showing possible positions for display screens in addition to the license plate and rear lights and turn indicators, where 10E and 10F are to the rear left and rear right of the vehicle on panels on the rear of the vehicle, and 10D is a display panel on the lid of the trunk;

FIG. 3 is a schematic representation of a hatchback 6 showing possible positions for display screens in addition to the license plate and rear lights and turn indicators, where 10E and 10F are to the rear left and rear right of the vehicle on panels built into or attached to the rear bumper, and 10G is a panel on the rear door of the vehicle, and 10D is a display panel on the lid of the trunk;

FIG. 4 is a schematic representation of a luxury car where 10H is a panel on the back of the lid of the trunk and 101 is a panel on the rear bumper;

FIG. 5 is a schematic representation of a display 20 having various data displayed thereupon.

FIG. 6 is a schematic bird's eye view of a vehicle showing sideways illumination of the ground alongside the vehicle, as an indication of veering of vehicle or of danger of a door opening from a parked car;

FIG. 7 is a schematic bird's eye view of a vehicle showing back illumination of the ground behind the vehicle, as an indication of the vehicle reversing, and

FIG. 8 is a schemicatic view of the front of a vehicle showing information thereon for viewing by pedestrians, such as if it is safe to cross in front of the vehicle.

### DESCRIPTION OF EMBODIMENTS

Many autonomous and smart vehicles monitor other road users and respond via complex algorithms to avoid collisions. Consequently, however, there is a big gap between the capability of such vehicles and that of other road users including drivers of older and simpler cars, motorcyclists, bicyclists, pedestrians and other road users.

There is massive concern worldwide in introducing cost-effective technologies to reduce the occurrence and severity of road accidents and to promote safer driving.

In general the response time of a driver is a combination of his perception time and his reaction time, and the ability of the vehicle to respond to his reaction. Due to its intertia, in general, the faster the vehicle is travelling, the longer the response time.

The human perception time is typically ¼ to ½ a second, and the human reaction time, such as transferring the foot from the accelerator (gas pedal) to the brake pedal may vary from ¼ to ½ seconds. The total human contribution to stopping the vehicle may be two seconds, but the effects of tiredness, and alcohol can slow this to 3-4 seconds.

A vehicle travelling at 110 km/hr travels between 28 to 100 meters during a human response time of 1 to 4 seconds, before the brakes are applied.

Leading and following vehicles generally travel with the traffic flow at the same pace. The brake lights of the leading vehicle only come on when the driver thereof has perceived and reacted to a hazard. Thus the following vehicle who is not keeping his distance from the vehicle in front (tailgating) may be unable to stop when the brake lights of the leading vehicle provide warning that the leading vehicle is slowing down or stopping. Such crashes are all too frequent. It is noted that (correctly), in absence of strong evidence to the contrary, insurance policies and the law assume that in the event of a collision, the driver of the following vehicle responsible. He is also most at risk. It will be appreciated that the following car that crashes into the rear of a leading car is itself often followed by a further car, and in such instances, the second car typically comes to an abrupt halt with minimum notice and it not infrequently happens that the third car crashes into the second, and a multiple vehicle collision may ensue. multiple vehicle collision is a road traffic accident involving many vehicles. Generally occurring on high-capacity and high-speed routes such as freeways, multiple vehicle collisions are one of the deadliest forms of traffic accidents. The most disastrous pile-ups have involved more than a hundred vehicles.

Thus any shortening of the following driver's perception+reaction time will reduce the time required for the stopping process and minimize crashes and may save lives, prevent accidents or minimize their severity.

Early warning to a following driver both provides earlier perception of a hazard and can trigger behavior such as the following driver easing his/her foot off the accelerator or covering the brakes, slowing the vehicle down before actually braking and responding earlier if necessary.

It will be appreciated that for many decades until very recently, car lamps have traditionally been filament bulbs which draw large currents and may dim over a measurable time. Leaving the headlamps on, or even leaving a dim inner light of a car on whilst parked can and does drain the accumulator.

In recent years there has been a revolution in illumination technologies, with flat screen full colour pixilated displays such as those based on solid state light emitting diodes LEDs being available in a range of colors at low cost. Early LEDs were made of aluminum gallium indium phosphide (AlGalnP) and are red, or of indium gallium nitride (InGaN) alloys and are green. Typically indicator LEDs draw very low currents, of milliamps, and so do not drain the lead—acid accumulator (car battery) of power.

Nowadays, LEDs are available in a wide range of colours including orange and yellow (also AlGalnP) and blue or white (InGaN) but can be made in any shape or size, and can be used as pixels of an array to show create simple graphical images. Since the ON/OFF response of LEDs is very rapid, such simple graphical images can change dynamically. By mounting different LEDs in close proximity or by using LEDs with a plurality of band-gaps that can produce more than one color, it is possible to change the color of such images as well.

Indicator lights on vehicles are generally binary. They are either OFF or ON. Turn signal lights flash, but this is simply to draw attention to them, and no additional information is imparted, other than the driver intending to turn, apart from when both turn signal lights flash together in synchrony which is used as a hazard warning signal.

Whilst some brake lights have variable intensity, such as that described in U.S. Pat. No. 5,481,243 this is not all that readily discernable to drivers of following vehicles and the like.

U.S. Pat. No. 6,268,792 to Newton describes a progressive brake light gauge that comprises a lamp assembly including a plurality of horizontally oriented, linearly aligned lamps with perhaps an illuminable peripheral lamp situated about a perimeter of the linear aligned lamps, the lamp assembly is mounted on a rear of the vehicle, each lamp of the lamp assembly is adapted to illuminate upon the actuation thereof. Also included is a mode selection switch for allowing a user to select the operation of the system in one of four modes including a first mode of operation, a second mode of operation, a third mode of operation, and a fourth mode of operation; a memory means for continuously monitoring the deceleration detected by the accelerometer and further storing the maximum deceleration detected, wherein the memory means is adapted to be reset; and control means connected between the accelerometer, lamp assembly, mode selection switch and memory means, the control means, in the first mode of operation, adapted to actuate the lamps from center lamps of the lamp assembly to end lamps as the detected deceleration increases wherein the peripheral lamp is illuminated only upon the detection of the maximum deceleration, the control means, in the second mode of operation, adapted to actuate the lamps from the end lamps to the center lamps as the detected deceleration increases wherein the peripheral lamp is illuminated upon the detection of any deceleration, the control means, in the third mode of operation, adapted to actuate the lamps from one set of the end lamps to another set of the end lamps as the detected deceleration increases wherein the peripheral lamp is illuminated only upon the detection of the maximum deceleration, the control means, in the fourth mode of operation, adapted to actuate the lamps from one set of the end lamps to another set of the end lamps as the detected deceleration increases wherein the peripheral lamp is illuminated upon the detection of any deceleration.

In a first embodiment, at least one display is provided on the rear of a vehicle, the display comprising a pixilated array such as an array of LEDs; the display being linked to the on board computer of the vehicle either directly or by monitoring signals to and from the computer or to the Controller Area Network (can-bus) which is a robust vehicle bus standard designed to allow microcontrollers and devices to communicate with each other in applications without a host computer. It is a message-based protocol, designed originally for multiplex electrical wiring within automobiles from various sensors and controls, that monitor changes in the trajectory of the leading vehicle, wherein said display provides a real-time non-binary illuminated warning of variable surface area in response to detected changes in trajectory.

FIG. 1 is a schematic representation of the rear of a vehicle 2, specifically a family saloon car, showing possible positions for display screens, with one display screen 10A being positioned to the rear left of the vehicle, and a second display screen 10B being displayed to the rear right of the vehicle 2 on panels near the lid of the trunk, in addition to the license plate and rear lights and turn indicators, and a further display screen 10C being positioned on the bumper which is a structure attached to or integrated with the front and rear ends of a motor vehicle, to absorb impact in a minor collision, ideally minimizing repair costs. Stiff metal bumpers appeared on automobiles as early as 1904 that had a mainly ornamental function. Numerous developments, improvements in materials and technologies, as well as greater focus on functionality for protecting vehicle components and improving safety have changed bumpers over the years. Bumpers ideally minimize height mismatches between vehicles and protect pedestrians from injury. Regulatory measures have been enacted to reduce vehicle repair costs, and more recently impact on pedestrians.

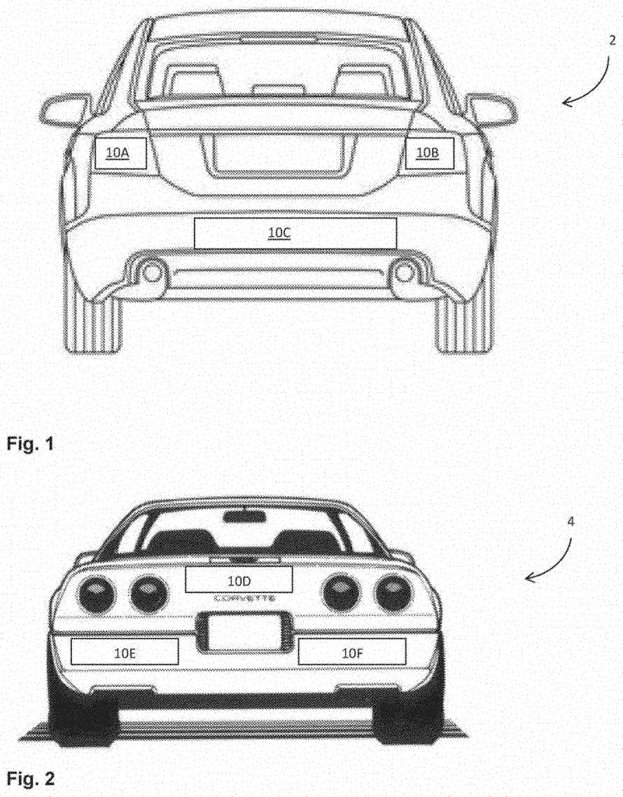

FIG. 2 is a schematic representation of the rear of a vehicle 4, specifically a sports car, such as a corvette showing possible positions for display screens on the rear of the vehicle, in addition to the license plate and rear lights and turn indicators, showing a rear left display screen 10E, a rear right display screen 10F and a central display panel 10D on the back facing panel of the lid of the trunk.

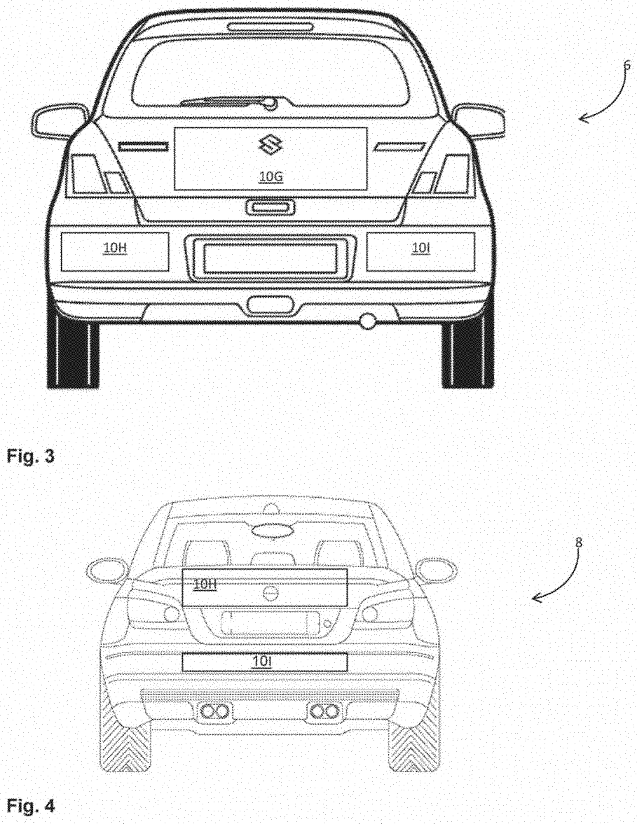

FIG. 3 is a schematic representation of a hatchback 6 showing possible positions for display screens in addition to the license plate and rear lights and turn indicators, where a rear left display screen 10E is fixed to the left of the bumper, and a rear right display screen 10F is fixed to the right of the bumper, and a large display screen 10G is fixed to the rear door of the vehicle. The display screen.

FIG. 4 is a schematic representation of a vehicle 8, specifically a luxury car having a display panel 10H on the back of the lid of the trunk and a further display panel 101 on the rear bumper.

The display panels 10X are preferably pixilated arrays and are most preferably arrays of light emitting diodes LEDs so may surround and include logos as shown with display screens 10G and 110H for example. Preferably the display screen has at least the colors red yellow and green. The display panels 10X are used to display additional information not usually shown by the standard braking, rear and turn lights of the vehicle. For example, where the vehicle has an automatic gear box, reduction in pressure on the accelerator is detected by the onboard computer or can-bus and a yellow indication is displayed on the display. In some embodiments the size of the yellow display is an indication of the rate of deceleration. In vehicles with manual gearboxes, this no such yellow indication is given as it may provide false indications of the vehicle's trajectory.

Where the leading vehicle 2 (4, 6, 8) has installed therein, a radar or video system with image analysis for detecting hazards in front of the leading vehicle, images corresponding to the hazards may be displayed on the display 10X on the rear of the leading vehicle 2 (4, 6, 8) to provide information to following road users.

Side displays 10A, 10B (10E, 10F) are usually provided in pairs, since the rear of a vehicle 2 (4) is typically symmetrical Where the onboard computer or can-bus or the radar, laser, satellite navigation system or video system detect that the vehicle 2 (4, 6, 8) is moving to the left or right, either via the steering wheel, or from changing proximity to lane markings detected by a laser based driver warning system, such as AWACS™ or Mobileye™, detected information selected from that displayed to the driver of the system provided with the laser based driver warning system is displayed as a non-binary display on the rear display to the following driver, typically as a solid arrow to the left on a left side display 10A, 10E, 10H, and a solid arrow pointing to the right on a right side display 10B, 10F, 101, could indicate a veer to the right.

Where a central display is provided, it may show an arrow pointing in the desired direction.

In general, the displayed information is informative. Preferably it includes icons, signs or glyphs.

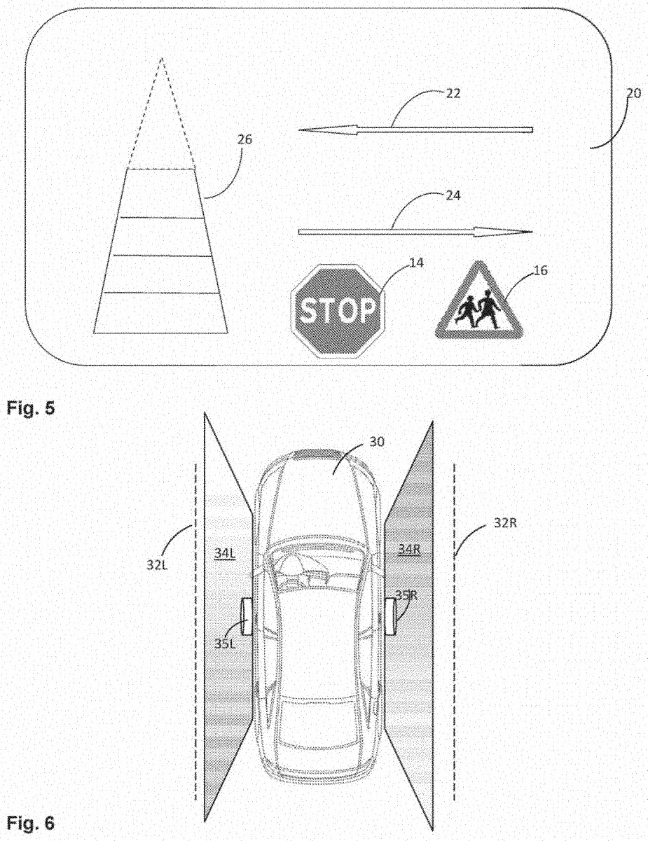

With reference to FIG. 5, a display 20 is shown having various data displayed thereupon. If the display 20 is attached to the rear of a leading vehicle, the driver of a following vehicle is able to see this data dispayed on the display of the leading vehicle and to take appropriate action.

Preferably the displayed information is intuitive. It may be symbolic. For example, internationally, a red octagon 14 indicates stop, and no other sign is this shape. A triangular symbol 16, particularly a triangle with a red border is a warning. Although in FIG. 5 the stop sign 14 itself is shown, with the word stop thereon, it will be appreciated that a red octagonal alone, or the word STOP alone has almost as much impact.

In some embodiments the information displayed is graphical. In others it is alpha-numeric, such as a number indicating speed, a letter such as L or R for left or right, or, indeed the word left or right, but in such cases the information consists of single short words and not sentences for ease of comprehension.

In some embodiments the color of the display is intuitive with red indicating a hazard, yellow providing advanced warning of likely change in trajectory and green indicating that the leading vehicle is likely to continue on its trajectory.

For example, the display may comprise a graded triangle 26 or a line or arrow 22, 24, the extent of which being indicative of the extent of that indicated, so a long arrow to the left 22 could indicate a sharp deviance to the left. Likewise a long arrow to the right 24 might indicate a sharp deviance to the right. This is different from flashing turn light since it does not indicate driver's intent to change lanes or to turn at a junction, but rather the movement of the host vehicle in relation to its forward trajectory, i.e. the host vehicle veering from the straight ahead direction, possibly together with the winding of the road itself, or, using information determined by a laser Doppler system (Ladar), a radar system, a satellite navigation system, an onboard camera with image analysis or similar, to the vehicle veering with respect to its lane.

Optionally the data displayed is alpha-numeric. Optionally the data displayed is graphical.

Optionally, the data displayed comprises a bar or triangle whose extend is indicative of the severity of the change in trajectory.

Thus a graded green forward triangle 26 could indicate acceleration of the host vehicle having the display 20 on its rear to drivers of following vehicles.

With the aid of Ladar, radar, a camera with image analysis and the like, pedestrians in from of a vehicle 2 may be detected and an indication of pedestrians may be displayed on the rear screen 20 showing the standard road signal graphic for pedestrians to give additional warning to following drivers.

The general purpose of embodiments of the invention is to create a better understanding between drivers by presenting the detected intention of a driver prior to it happening.

It will be appreciated that more information about the driving and expected trajectory of a leading vehicle and allowing the following vehicle to predict the intention of the leading driver may help to reduce the stress levels of the following driver.

In some embodiments, a visual indication of any significant turning of steering wheel by a driver of a leading vehicle is displayed on rear display for viewing by the driver of a following vehicle.

This displayed signal could be a constant illumination of side indicators that contrasts with the blinking signal indicating intention to turn.

With reference to FIG. 6 a schematic bird's eye view of a vehicle 30 is shown. Also shown are lane markings 32L and 32 R on the left and right of the vehicle. In some embodiments, side indication lamps 35L, 35R are attached to the sides of the vehicle 30 and projected on to the ground surface 34L, 34R to the left and right of the vehicle 30. These side indication lamps 35L, 35R provide advanced of warning of lane changes and turning.

In some embodiments, the invention is directed to providing sideways illumination of the road or sidewalk alongside a stationary vehicle 30 to a distance of about 1 meter, to indicate to passersby, particularly to motorcyclists or cyclists, that the vehicle 30 has recently parked, thereby warning of the danger of a door opening suddenly which is well-documented as being a major cause of accidents involving motorcyclists or cyclist.

In preferred embodiments, a vehicle 30 that just parked will indicate this fact by low level illumination to other road users. However, in a preferred embodiment, if the driver turns off the engine, or the driver or a passenger touches a door handle, this causes the illumination of the ground to the side of the vehicle to be increased in intensity and/or to flash and or to change from white or yellow to red, thereby warning other road users of a clear imminent danger. In some embodiments, this indication may be only on the side of the vehicle of the door whose handle was touched.

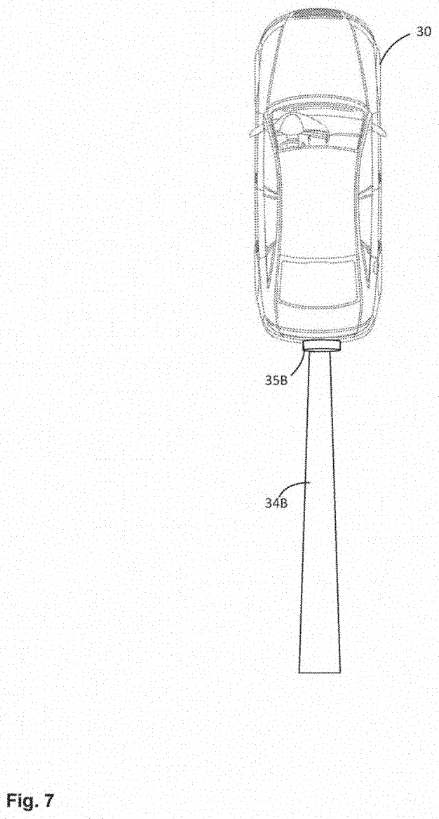

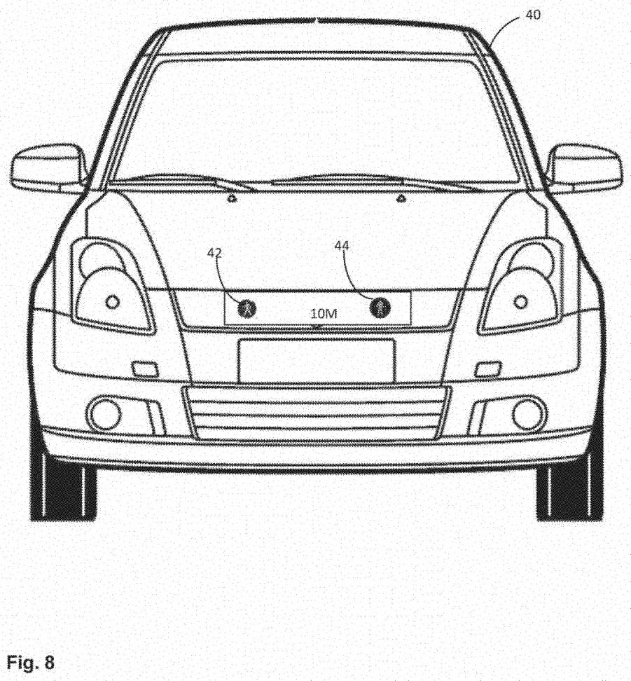

The standard signal indicating that a vehicle is reversing is the illumination of a white light on the rear of the vehicle. Sometimes, particularly with lorries, coaches and other vehicles where the driver has poor rear vision, sometimes this signal is augmented by a high pitched steady or beeping audible signal. With reference to FIG. 7, in an embodiment of the invention, a rear lamp 35B is provided that illuminates a beam on the road 34B behind the vehicle 30 ather like a weak dipped headlamp illuminates the road in front of a vehicle. This will more intuitively indicate that the vehicle 30 is reversing and thus the fact that the vehicle 30 is reversing will be detected more quickly by other road users. In some embodiments, the distance illuminated may provide an indication of the speed of reversal or the length of the reversing vehicle 30.

With reference to FIG. 8, in some embodiments, a forward facing display 10M may be provided on the front of the vehicle 40 to provide an indication of a driver's intent to road users in front of the vehicle. In some embodiments, the front display 10M may be coupled to a video camera with image analysis, radar or laser system. Thus if a crossing and a person waiting to cross is detected, when the vehicle slows down as it approaches or stops, a green walking man 42 may be displayed to indicate to persons waiting to cross that it is safe to do so. On the other hand, if the driver is going too fast to stop as a traffic light (robot) flashes amber, an image of a red man 44 standing could indicate this fact to pedestrians.

It will be appreciated that displays of the invention are applicable for manually controlled vehicles, for vehicles in a cruise control mode and for the autonomous vehicles that are being developed.

Providing an early indication to other road users of the likely trajectory of a vehicle, whether manually controlled or autonomous, will help these other road users make better and faster decisions, responding more promptly.

Thus persons skilled in the art will appreciate that the present invention is not limited to what has been particularly shown and described hereinabove. Rather the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising and the like indicate that the components listed are included, but not generally to the exclusion of other components.

1-38. (canceled)

39. A warning system for a vehicle comprising:
a) one or more lights positioned on a surface of the vehicle
b) one or more detectors detects and/or monitoring any one or more of an acceleration of the vehicle, a deceleration of the vehicle, and cruising of the vehicle; and
c) a processor configured to illuminate one or more of the lights when an acceleration of the vehicle, a deceleration of the vehicle, or cruising of the vehicle is detected.

40. The system according to claim 39 wherein one or more of the detectors detects and/or monitors a position of an accelerator pedal of the vehicle and/or an autonomous acceleration or deceleration or cruising of the vehicle and/or a communicably connected acceleration or deceleration or cruising of the vehicle.

41. The system according to claim 39 wherein one or more of the detectors detects and/or monitor a position of a foot brake of the vehicle and/or an autonomous braking of the vehicle and/or a communicably connected braking of the vehicle.

42. The system according to claim 39 comprising two or more lights, and a number of lights are illuminated by the processor in a predetermined temporal and/or spatial pattern as the deceleration progresses.

43. The system according to claim 42 wherein the number of lights illuminated by the processor increases as the deceleration progresses.

44. The system according to claim 42 wherein the predetermined pattern includes a color change of the illuminated lights as the deceleration progresses.

45. The system according to claim 42 wherein an intensity of illumination of one or more of the lights changes as the deceleration progresses.

46. The system according to claim 39 comprising two or more lights, and a number of lights are illuminated by the processor changes in a predetermined temporal or spatial pattern as the acceleration progresses.

47. The system according to claim 46 wherein the number of lights illuminated by the processor increases as the acceleration progresses.

48. The system according to claim 46 wherein the predetermined pattern includes a color change of the illuminated lights as the acceleration progresses.

49. The system according to claim 46 wherein an intensity of illumination of one or more of the lights changes as the acceleration progresses.

50. The system according to claim 39 wherein one or more of the detector monitors the speed of the vehicle and the processor is configured to calculate the acceleration and/or deceleration of the vehicle.

51. The system according to claim 39 wherein the vehicle is an autonomously driven vehicle.

52. The system according to claim 39 wherein the vehicle is configured to communicate to other vehicles that an acceleration, deceleration or cruising of the vehicle has been detected.

53. A warning system for a vehicle comprising:
a) one or more lights positioned on a rear surface of the vehicle;
b) one or more detectors detecting or monitoring when the vehicle is travelling in reverse by a human driver and/or by an autonomous system and/or by a communicably connected system;
c) a processor configured to flash on and off one or more of the lights postponed on the rear surface of the vehicle when the vehicle is travelling in reverse.

54. The system according to claim 53 wherein the processor is configured to flash the lights on and off in a temporal and/or spatial pattern as the reverse travel of the vehicle progresses.

55. The system according to claim 54 wherein a frequency of the flashing of the lights changes as the reverse travel of the vehicle progresses.

56. The system according to claim 54 wherein a color of the illuminated lights changes as the reverse travel of the vehicle progresses.

57. The system according to claim 54 wherein an intensity of illumination of one or more of the lights changes as the reverse travel of the vehicle progresses.

58. The system according to claim 53 wherein the vehicle is an autonomously driven vehicle

59. The system according to claim 53 wherein the vehicle is configured to communicate to other vehicles that the vehicle is traveling in reverse.

60. A warning system for a vehicle comprising:
a) one or more lights positioned on a side surface of the vehicle;
b) one or more detectors detecting any one or more of: (i) an engine of the vehicle has is turned off, (ii) a parking brake of the vehicle is in an applied position, (iv) a steering wheel of the vehicle and/or an autonomously steering system of the vehicle and/or a communicably connected steering system of the vehicle is turned to the left or to the right, and (v) when a transmission of the vehicle is in park;
c) a processor configured to illuminate one or more of the lights when one or more of the detectors has detected any one or more of: (i) an engine of the vehicle has is turned off, (ii) a parking brake of the vehicle is in an applied position, (iv) a steering wheel of the vehicle and/or an autonomously steering system of the vehicle and/or a communicably connected steering system of the vehicle is turned to the left or to the right, and (v) when a transmission of the vehicle is in park.

61. The system according to claim 60 wherein the processor is configured to flash the lights on and off in a temporal and/or spatial pattern.

62. The system according to claim 61 wherein a frequency of the flashing of the lights changes with time.

63. The system according to claim 61 wherein a color of the illuminated lights changes with time.

64. The system according to claim 61 wherein an intensity of illumination of one or more of the lights changes with time

65. The system according to claim 60 wherein the vehicle is an autonomously driven vehicle.

66. The system according to claim 60 wherein the vehicle is configured to communicate to other vehicles.
